(19) United States
(12) Patent Application Publication
(10) Pub. No.: US 2016/0196145 A1
(43) Pub. Date: Jul. 7, 2016

(54) BOOT FROM MODIFIED FACTORY IMAGE

(71) Applicant: Hewlett-Packard Development Company, L.P., Houston, TX (US)

(72) Inventors: Fletcher Liverance, Kent, OH (US); Matthieu Clemenceau, Houston, TX (US)

(21) Appl. No.: 14/911,007

(22) PCT Filed: Aug. 8, 2013
(86) PCT No.: PCT/US2013/054157

§ 371 Date: Feb. 8, 2016

(51) Int. Cl. G06F 9/44; G06F 1/24

(52) U.S. Cl. CPC G06F 9/441; G06F 1/24

(57) ABSTRACT

A difference between a current configuration of a device and a factory image of the device is determined in response to a user request. A factory image of a device is modified to include the determined difference between the current configuration and the factory image. The device is booted from the modified factory image, if a factory reset of the device is triggered.

### BACKGROUND

A device may include a factory image that retains the original settings or state of the device, even after a user has customized the device. Sometimes, the user may wish to undo these customizations. Thus, the user may trigger a factory reset that causes the device to boot from the factory image and therefore revert to its original state.

### BRIEF DESCRIPTION OF THE DRAWINGS

The following detailed description references the drawings, wherein:

FIG. 1 is an example block diagram of a device to boot from a modified factory image;

FIG. 2 is another example block diagram of a device to boot from a modified factory image;

FIG. 3 is yet another example block diagram of a device to boot from a modified factory image;

FIG. 4 is an example block diagram of a computing device including instructions for booting from a modified factory image; and

FIG. 5 is an example flowchart of a method for booting from a modified factory image.

### DETAILED DESCRIPTION

Specific details are given in the following description to provide an understanding of examples of the present techniques. However, it will be understood that examples of the present techniques may be practiced without these specific details. For example, systems may be shown in block diagrams in order not to obscure examples of the present techniques in unnecessary detail. In other instances, well-known processes, structures and techniques may be shown without unnecessary detail in order to avoid obscuring the examples of the present techniques.

A user may customize a device by changing settings, installing applications, and the like. Some devices may include factory image, which retains the original settings or state of the device before the user customized the device. Customization of the device may lead to undesirable outcomes, such as increased latency or even freezing of an operating system or application. Thus, a user may seek to resolve these undesirable outcomes by restoring the device to its original state, which may be carried out by a factory reset. The device may boot from the factory image during the factory reset. However, while the factory reset may alleviate performance issues, the user's customizations and/or data is lost in the process. For example, the user may then need to reinstall applications and/or redo settings after the factory reset.

This may reduce a value of the factory reset because the user may wish to reset the device but still maintain critical updates. Moreover, the user is generally prevented from making any permanent changes to the factory image, such as add-ons, security updates, and customer modifications. High volume users may be able to seek out a vendor or manufacturer to create a special factory image that contains the user's changes. However, this may still be an inconvenient, expensive and/or lengthy process for the user, vendor and/or manufacturer. In addition, most users would not even have this option available.

Examples of present techniques may allow a user to modify the factory image so as to lock in customizations to the device. Moreover, the user may be able to choose when to lock in these customizations. An example device may include a modification unit and an image unit. The modification unit may determine a difference between a current configuration of the device and a factory image of the device in response to a user request. The image unit may modify the factory image of the device to include the determined difference between the current configuration and the factory image. The device may boot from the modified factory image if a factory reset is triggered.

Hence, examples of present techniques may now allow user to create their own factory resettable images. For example, the user may quickly reset the device on-site using a self-modified factory image. As a result, the user may be able to avoid having to reinstall, update and/or reconfigure the device afterward. This may lead to cost and/or time savings for both the user and vendors/providers supporting the user.

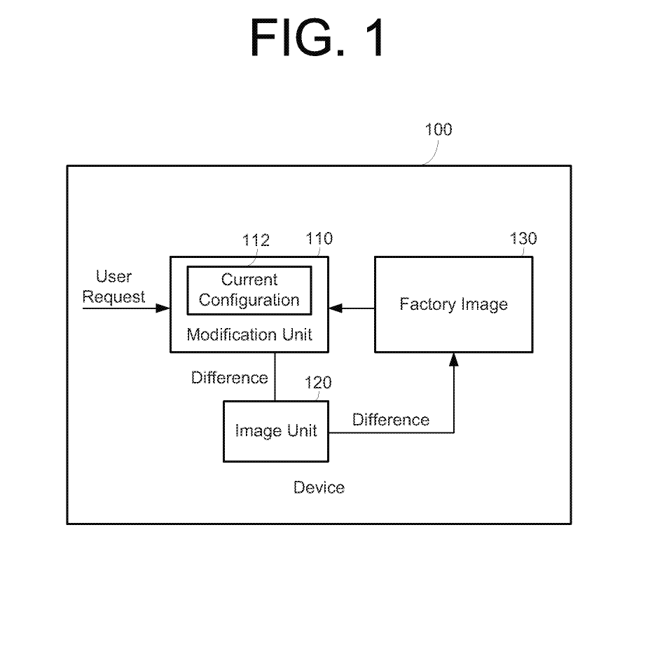

Referring now to the drawings. FIG. 1 is an example block diagram of a device 100 to boot from a modified factory image. The device 100 may couple to or be included in any type of computing device including a factory image, such as a notebook computer, a desktop computer, an all-in-one system, a server, a network device, a wireless device, a storage device, a mobile device, a thin client, a retail point of sale device, a gaming device, a scientific instrument, and the like.

In the example of FIG. 1, device 100 includes a modification unit 110, an image unit 120 and a factory image 130. However, examples of the device 100 may also have the factory image 130 being external to the device 100. The modification and image units 110 and 120 may include, for example, a hardware device including electronic circuitry for implementing the functionality described below, such as control logic and/or memory. In addition or as an alternative, the modification and image units 110 and 120 may be implemented as a series of instructions encoded on a machine-readable storage medium and executable by a processor.

The factory image 130 may relate to an original operating system (OS) or original equipment manufacturer (OEM) custom OS image that comes with the device 100. Examples of the OS 130 may include Android, BSD, iOS, GNU/Linux, OS X, QNX, Microsoft Windows, Windows Phone, IBM z/OS and the like. For example, the factory image 130 may include the original setting(s), document(s), application(s) and/or operating system(s) initially installed on the device 100 by the manufacturer or vendor and before a user has modified or customized the device 100. The term image or disk image may relate to a single file or storage device containing the complete contents and structure representing a data storage medium or device, such as a hard drive, tape drive, floppy disk, optical disc, or USB flash drive.

A disk image may be created by creating a sector-by-sector copy of the source medium and thereby replicating the structure and contents of a storage device. The factory image 130 may be used by a user to restore the device 100 to previous or original settings. For example, the user may install an application to or change a setting of the device 100, which causes the device 100 to malfunction or operate at a degraded or unintended state, such as freezing. Moreover, the user may be unable to determine or undo the change that causes the device 100 to perform unsatisfactorily. By reverting to the factory image 130, the user may undo the harmful or unintended change(s). However, reverting to the factory image 130 may also cause any data stored in the device (and not included in the factory image 130) to be lost, similar to reformatting a hard drive.

The factory image 130 may also be used a golden image by a vendor or manufacturer. The term golden image may refer to a template for a virtual machine (VM), virtual desktop, server or hard disk drive. A golden image may also be referred to as a clone image, master image or base image. For example, to create a golden image, an administrator may first set up a computing environment as intended and then save the disk image as a pattern for making more copies. The use of golden images can save time and ensure consistency by eliminating or reducing the need for repetitive configuration changes and performance tweaks.

The modification unit 110 may determine a difference between a current configuration 112 of the device 100 and a factory image 130 of the device 100 in response to a user request. The current configuration 112 may relate a configuration of or modification to file(s), application(s), and the OS. The difference between the current configuration 112 of the device 100 and the factory image 130 may relate to adding, modifying and/or deleting of a file, application and/or OS of the device. For example, the difference between the current configuration 112 and the factory image 130 may include changes to the settings of the OS, newly created documents and/or recently installed applications. The user request may be triggered or initiated by the user via a user interface (not shown) of the device 100, such as a graphical user interface (GUI), a display, a keyboard and the like. For instance, an application of the OS may allow the user to trigger the user request.

The image unit 120 may modify the factory image of the device to include the determined difference between the current configuration 112 and the factory image 130. For example, if the determined difference between the current configuration 112 and the factory image 130 are changes to the settings of the OS and additional applications being installed, image unit 120 may modify the factory image to include the changed settings of the OS and additional applications.

The modification unit 110 may not determine the difference between the current configuration 112 and the factory image 130 if the user request is not received. Similarly, the image unit 120 may not modify the factory image 130 if the user request is not received. Thus, the factory image 130 may only be modified when the user seeks to have to user's customizations become more permanent by becoming part of the factory image 130. Moreover, the user may send multiple user requests over time. Thus, the user may be able to lock in subsequent changes into the factory image 130 as well. For example, the modification unit 110 may then determine the difference between the current configuration 112 and the modified factory image 130 a next time the user request is triggered.

The device 100 may then boot from the modified factory image 130 if a factory reset is triggered. The term booting may refer to initial set of operations that a computing device, such as a device 100, performs when electrical power to the computing device's processor is switched on. The term factory reset or master reset may refer to an initial set of operations that trigger a full restore of the device 100 to its factory or previous settings, such as by reverting to the factory image 130. Here, as examples modify the factory image 130, the user may be able to avoid having to redo configuration changes and/or install applications even after the factory reset is triggered.

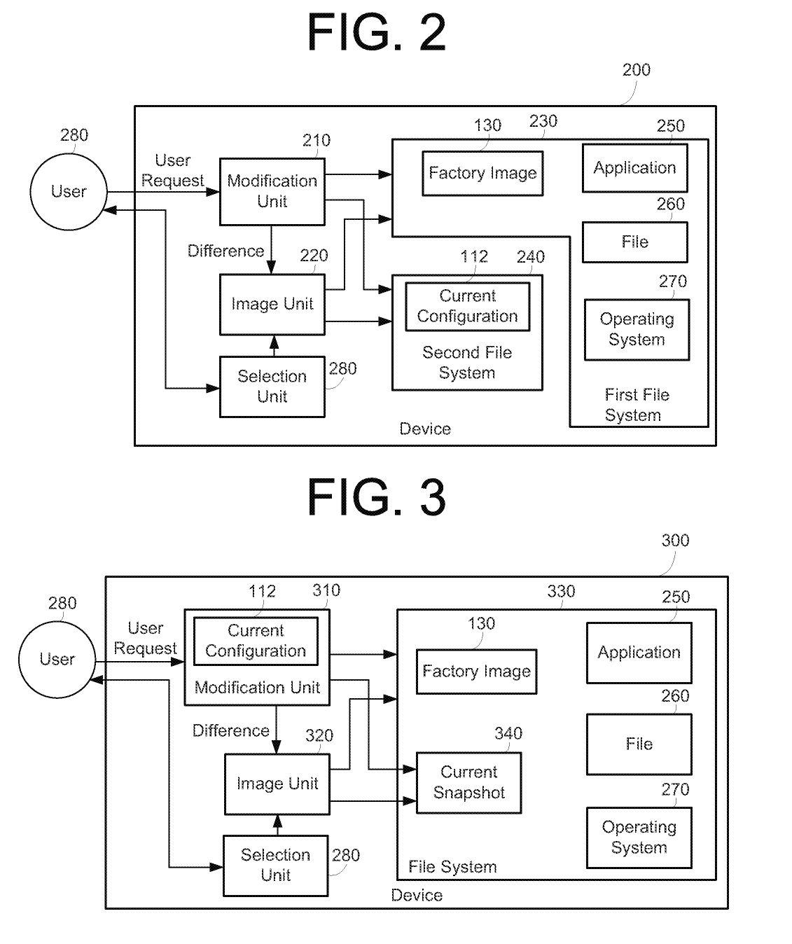

FIG. 2 is another example block diagram of a device 200 to boot from a modified factory image. The device 200 may couple to or be included in any type of computing device including a factory image, such as a notebook computer, a desktop computer, an all-in-one system, a server, a network device, a wireless device, a storage device, a mobile device and the like.

The device 200 of FIG. 2 may include at least the functionality and/or hardware of the device 100 of FIG. 1. For example, the device 200 of FIG. 2 includes the factory image 130. Moreover, the device 200 includes a modification unit 210 that includes the functionality and/or hardware of the modification unit 110 of FIG. 1 and an image unit 220 that includes the functionality and/or hardware of the image unit 120 of FIG. 1. The device 200 further includes a first file system 230, a second file system 240 and a selection unit 280.

The first file system 230 is shown to include the factory image 130, an application 250, a file 260, and an OS 270. The second file system 240 is shown to include the current configuration 112. While the selection unit 280 is shown to be external to the first and second file systems 240 and 250, examples of the selection unit 280 may be included in at least one of the first and second file systems 240 and 250. Further, examples of the application 250, a file 260 and/or OS 270 may instead be located in the second file system 240 or both of the first and second file systems 230 and 240.

The first and second file system 230 and 240 may include, for example, a hardware device including electronic circuitry for implementing the functionality described below, such as control logic and/or memory. In addition or as an alternative, the first and second file system 230 and 240 may be implemented as a series of instructions encoded on a machine-readable storage medium and executable by a processor.

A file system may be a type of data store which can be used to store, retrieve and update a set of files. A file may be a collection of data elements grouped together for the purposes of access control, retrieval, and modification. The file system may manage access to both the content of files and the metadata about those files. Further, the file system may be responsible for arranging storage space, reliability, and efficiency.

In FIG. 2, the first file system 230 may be a read-only file system, such as SquashFS. SquashFS is a compressed read-only file system for Linux. The second file system 240 may be a read-write file system, such as AUFS, that includes a union amount for other file systems. The union mount is a mount that allows several file systems to be mounted at one time, appearing to be one file system. Files and directories of separate file systems, known as branches, may be transparently overlaid, forming a single coherent file system. When mounting branches, the priority of one branch over the other is specified. So when both branches contain a file with the same name, one gets priority over the other. Here, the second file system 240 may have priority over the first file system 230.

In FIG. 2, the modification unit 210 may lock the second file system 240 such that no writes can occur and all file handles are closed. Then, the modification unit 210 may determine the difference between the current configuration 112 of the device 200 and the factory image 130 by analyzing the second file system 240. For example, as explained above, any changes directed towards the first file system 230 may stored at the second file system 240. These changes may be analyzed to determine the difference between the current configuration 112 and the factory image 130. The modification unit 210 may next unlock the second file system 240 after determining the difference.

Next, the image unit 220 may merge the changes from the second file system 240 into the first file system 230 in order to modify the factory image 130 to match the current configuration 112 of the device 200. The image unit 220 may then wipe and reinitialize the second file system 240 after the changes are merged, as the changes from the second file system 240 are now stored at the first file system 230.

The selection unit 280 may include, for example, a hardware device including electronic circuitry for implementing the functionality described below, such as control logic and/or memory. In addition or as an alternative, the selection unit 280 may be implemented as a series of instructions encoded on a machine-readable storage medium and executable by a processor.

The selection unit 280 may allow the user to select which of differences between the current configuration 112 and the factory image 130 are to be recorded to the factory image 130 by the image unit 220, if the modification unit 210 determines a plurality of differences. For example, the user may customize the device 200 according the user's preferences, such as by changing settings or installing applications. At a later time, the user may trigger the user request to have these customizations to the device 100 locked in. However, the user may not wish to have all the customizations locked in. The selection unit 280 may allow the user to select which of customizations to merge with the factory image, such as via the user interface (not shown).

FIG. 3 is yet another example block diagram of a device 300 to boot from a modified factory image. The device 300 may couple to or be included in any type of computing device including a factory image, such as a notebook computer, a desktop computer, an all-in-one system, a server, a network device, a wireless device, a storage device, a mobile device and the like.

The device 300 of FIG. 2 may include at least the functionality and/or hardware of the device 100 of FIG. 1. For example, the device 200 of FIG. 2 includes the factory image 130. Moreover, the device 200 includes a modification unit 310 that includes the functionality and/or hardware of the modification unit 110 of FIG. 1 and an image unit 320 that includes the functionality and/or hardware of the image unit 120 of FIG. 1. The device 200 further includes a file system 330 and the selection unit 280 of FIG. 2. While the selection unit 280 is shown to be external to the file system 330, examples of the selection unit 280 may also be included in the file system 330.

The file system 330 is shown to include the factory image 130 as well as the application 250, file 260, and OS 270 of FIG. 2. The file system 330 may include, for example, a hardware device including electronic circuitry for implementing the functionality described below, such as control logic and/or memory. In addition or as an alternative, the file system 330 may be implemented as a series of instructions encoded on a machine-readable storage medium and executable by a processor.

Unlike the device 200 of FIG. 2, the device 300 of FIG. 3 may include only the single file system 330. The file system 330 may be a copy-on-write file system, such as Btrfs. Thus, any changes directed toward the factory image 130 may recorded at a separate location. The file system 330 and/or device 300 may take an initial snapshot of the device 300, where the initial snapshot is the factory image 130. The term snapshot may refer a state of a system, such as the OS 270 or device 300, at a particular point in time. The snapshot may be an actual copy of the state of the system and/or a log of changes to or capability provided by the system.

The modification unit 310 may indicate to the file system 330 to take a current snapshot 340 in response to the user request. Then, the modification unit 310 may determine a difference between a current configuration 112 of the device 300 and the factory image 130 by comparing the current snapshot 340 to the factory image 130. Next, the image unit 320 may replace the factory image 130 (or initial snapshot) with the current snapshot 340, in order to modify the factory image 130 to match the current configuration 112 of the device 300. Thus, the device 300 may then boot from the current snapshot 340 if the factory reset is triggered.

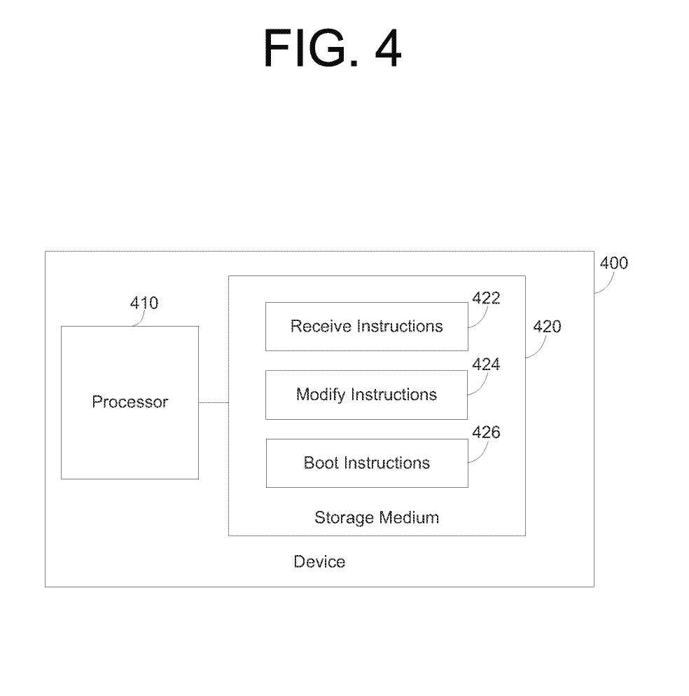

FIG. 4 is an example block diagram of a computing device 400 including instructions for booting from a modified factory image. In FIG. 4, the computing device 400 includes a processor 410 and a machine-readable storage medium 420. The machine-readable storage medium 420 further includes instructions 422, 424 and 426 for booting from a modified factory image.

The computing device 400 may be, for example, a controller, a secure microprocessor, a notebook computer, a desktop computer, an all-in-one system, a server, a network device, a wireless device, or any other type of user device capable of executing the instructions 422, 424 and 426. In certain examples, the computing device 400 may include or be connected to additional components such as memories, sensors, displays, etc.

The processor 410 may be, at least one central processing unit (CPU), at least one semiconductor-based microprocessor, other hardware devices suitable for retrieval and execution of instructions stored in the machine-readable storage medium 420, or combinations thereof. The processor 410 may fetch, decode, and execute instructions 422, 424 and 426 to implement booting from the modified factory image. As an alternative or in addition to retrieving and executing instructions, the processor 410 may include at least one integrated circuit (IC), other control logic, other electronic circuits, or combinations thereof that include a number of electronic components for performing the functionality of instructions 422, 424 and 426.

The machine-readable storage medium 420 may be any electronic, magnetic, optical, or other physical storage device that contains or stores executable instructions. Thus, the machine-readable storage medium 420 may be, for example, Random Access Memory (RAM), an Electrically Erasable Programmable Read-Only Memory (EEPROM), a storage drive, a Compact Disc Read Only Memory (CD-ROM), and the like. As such, the machine-readable storage medium 420 can be non-transitory. As described in detail below, machine-readable storage medium 420 may be encoded with a series of executable instructions for booting from the modified factory image.

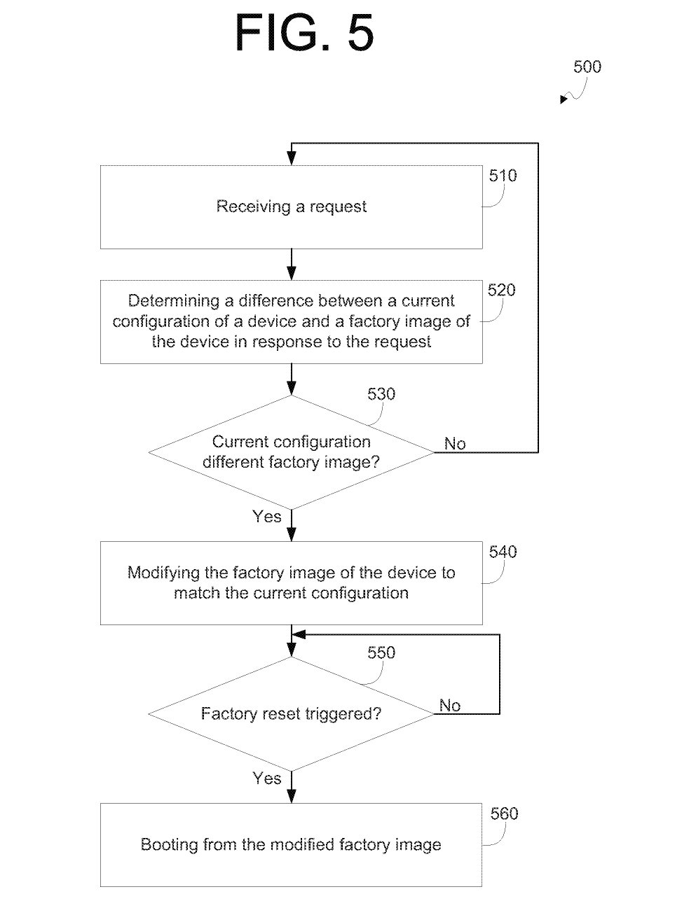

Moreover, the instructions 422, 424 and 426 when executed by a processor (e.g., via one processing element or multiple processing elements of the processor) can cause the processor to perform processes, such as, the process of FIG. 5. For example, the receive instructions 422 may be executed by the processor 410 to receive a request from a user. The modify instructions 424 may be executed by the processor 410 to modify a factory image of the device to match a current configuration of the device, in response to the request.

The factory image may not be modified if the request is not received from the user. The factory image may be modified by taking a snapshot to replace the factory image, if the device includes a single file system. However, the factory image may be modified by merging the current configuration into the factory image, if the device includes a plurality of file systems. The boot instructions 426 may be executed by the processor 310 to boot from the modified factory image, if a factory reset of the device is triggered.

FIG. 5 is an example flowchart of a method 500 for booting from a modified factory image. Although execution of the method 500 is described below with reference to the device 100, other suitable components for execution of the method 500 can be utilized, such as the devices 200 and 300. Additionally, the components for executing the method 500 may be spread among multiple devices (e.g., a processing device in communication with input and output devices). In certain scenarios, multiple devices acting in coordination can be considered a single device to perform the method 500. The method 500 may be implemented in the form of executable instructions stored on a machine-readable storage medium, such as storage medium 420, and/or in the form of electronic circuitry.

At block 510, the modification unit 110 of the device 100 receives a request from a user. Then, at block 520, the modification unit 110 determines a difference between a current configuration 112 of the device 100 and the factory image 130 of the device 100 in response to the request. The current configuration 112 may include a file, application and/or operating system of the device that has been added, modified and/or deleted by the user.

Next, at block 530, if the modification unit 110 determines that there is no difference between the current configuration 112 and the factory image 130, the method 500 flows back to block 510. Otherwise, if the modification unit 110 determines that there is a difference between the current configuration 112 and the factory image 130, the method 500 flows from block 530 to block 540. At block 540, the image unit 120 of the device 100 modifies the factory image 130 to match the current configuration 112. The modifying at block 540 may include taking a snapshot to replace the factory image 130 and/or merging the difference between current configuration 112 and the factory image 130 into the factory image 130.

Then, at block 550, the device 100 determines if a factory reset has been triggered, such as by the user. If the factory reset is not triggered, the device 100 may continue normal operations, at block 550. However, if the factory reset is triggered, the method 500 flows from block 550 to block 560. At block 560, the device 100 boots from the modified factory image 130, instead of the original factory image.

According to the foregoing, examples of present techniques provide a method and/or device that allows users to create their own factory resettable images. For example, a user may quickly reset the device on-site without having to reinstall, update and/or reconfigure the device afterward. This may lead to cost and/or time savings for both the user and vendors/providers supporting the user.

We claim:

1. A device, comprising:
a modification unit to determine a difference between a current configuration of the device and a factory image of the device in response to a user request; and
an image unit to modify the factory image of the device to include the determined difference between the current configuration and the factory image; wherein
the device is to boot from the modified factory image if a factory reset is triggered.

2. The device of claim 1, wherein the modification unit is to not determine the current configuration and the image unit is to not modify the factory image, if the user request is not received.

3. The device of claim 1, wherein,
the user is to trigger the user request, and
the modification unit is to determine the difference between the current configuration and the modified image a next time the user request is triggered.

4. The device of claim 1, further comprising:
a selection unit to allow the user to select which of differences between the current configuration and the factory image are to be recorded to the factory image by the image unit, if the modification unit determines a plurality of differences.

5. The device of claim 1, wherein the difference between the current configuration of the device and the factory image includes at least one of adding, modifying and deleting at least one of a file, application and operating system of the device.

6. The device of claim 1, further comprising:
a first file system and a second file system, wherein
the first file system is a read-only file system that stores the factory image, and
the second file system is to record any changes to the device from the factory image.

7. The device of claim 6, wherein,
the modification unit is to lock the second file system such that no writes can occur and all file handles are closed,
the modification unit is to determine the difference between the current configuration of the device and the factory image by analyzing the second file system, and
the modification unit is unlock the second file system after determining the difference.

8. The device of claim 7, wherein,
the image unit is to merge the changes from the second the system into the first file system in order to modify the factory image to match the current configuration of the device, and
the image unit is to wipe and reinitialize the second file system after the changes are merged.

9. The device of claim 1, further comprising:
a file system to take an initial snapshot of the device, the initial snapshot to be the factory image, wherein
the modification unit is to indicate to the file system to take a current snapshot in response to the user request, in order to determine the difference between a current configuration of the device and the factory image.

10. The device of claim 9, wherein,
the image unit is to replace the initial snapshot with the current snapshot in order to modify the factory image to match the current configuration of the device, and
the device is to boot from the current snapshot if the factory reset s triggered.

11. A method, comprising:
receiving a request;
determining a difference between a current configuration of a device and a factory image of the device in response to the request;
modifying the factory image of the device to match the current configuration, if the determining determines the current configuration and the factory image to be different; and
booting from the modified factory image, if a factory reset of the device is triggered.

12. The method of claim 11, wherein the modifying includes at least one of taking a snapshot to replace the factory image and merging the difference between the current configuration and the factory image into the factory image.

13. The method of claim 11, wherein the current configuration includes at least one of a file, application and operating system of the device that is at least one of added, modified and deleted by the user.

14. A non-transitory computer-readable storage medium storing instructions that, if executed by a processor of a device, cause the device to:
receive a request;
modify a factory image of the device to match a current configuration of the device, in response to the request; and
boot from the modified factory image, if a factory reset of the device is triggered, wherein
the factory image is not modified if the request is not received.

15. The non-transitory computer-readable storage medium of claim 14, wherein,
the factory image is modified by taking a snapshot to replace the factory image, if the device includes a single file system, and
the factory image is modified by merging the current configuration into the factory image, if the device includes a plurality of file systems.
